(19) United States
(12) Patent Application Publication
(10) Pub. No.: US 2024/0354663 A1
(43) Pub. Date: Oct. 24, 2024

(54) PERFORMANCE EVALUATION METHOD AND SYSTEM

(71) Applicant: SAMSUNG SDS CO., LTD., Seoul (KR)

(72) Inventors: Joon Ho LEE, Seoul (KR); Han Kyu MOON, Seoul (KR); Jae Oh WOO, Seoul (KR)

(73) Assignee: SAMSUNG SDS CO., LTD., Seoul (KR)

(21) Appl. No.: 18/636,548

(22) Filed: Apr. 16, 2024

(30) Foreign Application Priority Data
Apr. 18, 2023 (KR) 10-2023-0050916
Oct. 23, 2023 (KR) 10-2023-0141649

(51) Int. Cl. G06N 20/20

(52) U.S. Cl. CPC G06N 20/20

(57) ABSTRACT

A method for a performance evaluation may include: obtaining a first model trained using a labeled dataset of a source domain; obtaining a second model built by performing domain adaptation to a target domain on the first model; generating a pseudo label for an evaluation dataset of the target domain using the second model; and evaluating performance of the first model using the pseudo label. The evaluation dataset is an unlabeled dataset, and the generating of the pseudo label may include adjusting an upper limit of a size constraint of adversarial noise; deriving the adversarial noise for a data sample belonging to the evaluation dataset within a range that satisfies the size constraint; generating a noisy sample by reflecting the derived adversarial noise in the data sample; and generating a pseudo label for the data sample based on a predicted label of the noisy sample obtained through the second model.

### CROSS-REFERENCE TO RELATED APPLICATION

This application claims the benefit of Korean Patent Application No. 10-2023-0050916, filed on Apr. 18, 2023 in the Korean Intellectual Property Office, and Korean Patent Application No. 10-2023-0141649, filed on Oct. 23, 2023 in the Korean Intellectual Property Office, the disclosure of which is incorporated herein in its entirety by reference.

### BACKGROUND

### 1. Field

The present disclosure relates to a performance evaluation method and system, and more particularly, to a method and system for evaluating the performance of a model using an unlabeled dataset.

### 2. Description of the Related Art

Performance evaluation of a model (e.g., a deep learning model) is generally performed using a labeled dataset. For example, model developers divide labeled datasets into a training dataset and an evaluation (or test) dataset and evaluate the performance of a model using the evaluation dataset that has not been used for model learning (training).

However, since the evaluation dataset does not accurately reflect the distribution of a dataset generated in a real environment, it is not easy to accurately evaluate (measure) the actual performance of the model (i.e., the performance when deployed in the real environment). In addition, even if a labeled dataset in the real environment is prepared as the evaluation dataset, the distribution of the dataset generated in the real environment gradually changes over time. Therefore, in order to accurately evaluate the performance of the model, the evaluation dataset must be continuously updated (e.g., the evaluation dataset must be prepared again by performing labeling on the latest dataset). However, this requires considerable time and human costs.

Accordingly, the need for a method of accurately evaluating the performance of a given model using an unlabeled dataset is greatly increasing.

### SUMMARY

Aspects of the present disclosure provide a method of accurately evaluating the performance of a model of a source domain (e.g., the performance when deployed in a real environment) using an unlabeled dataset of a target domain (e.g., a dataset in the real environment) and a system for performing the method.

Aspects of the present disclosure also provide a method of accurately evaluating the performance of a model without using a labeled dataset used for model learning (training) and a system for performing the method.

Aspects of the present disclosure also provide a method of accurately generating a pseudo label of an unlabeled dataset used as an evaluation dataset and a system for performing the method.

Aspects of the present disclosure also provide a method of accurately adapting a model learned (trained) in a source domain to a target domain using an unlabeled dataset of the target domain and a system for performing the method.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

According to an aspect of one or more example embodiments of the present disclosure, a temporary model may be built by performing unsupervised domain adaptation to a target domain on a model of a source domain, and a pseudo label for an evaluation dataset may be generated using the temporary model. Accordingly, the performance of a given model (i.e., the performance of a source domain model for the target domain) can be easily evaluated even in an environment in which only unlabeled datasets exist or in an environment in which access to training datasets of the model is restricted. For example, the actual performance of the model (i.e., the performance when deployed in a real environment) can be easily evaluated by evaluating the performance of the model using an unlabeled dataset generated in the real environment. Further, time and human costs required for labeling the evaluation dataset can be reduced.

In addition, a noisy sample may be generated by adding adaptive adversarial noise to a data sample belonging to an evaluation dataset, and a pseudo label of the data sample may be generated based on a predicted label for the noisy sample. By using the pseudo label generated in this way, it is possible to evaluate the performance of the model very accurately (see Tables 1 and 2).

In addition, the performance of source models belonging to different source domains can be evaluated using an unlabeled dataset of a target domain, and a source model most suitable for the target domain can be accurately selected using the evaluation result.

In addition, an update time (or performance degradation time) of a model deployed in a specific domain can be accurately determined by repeatedly evaluating the performance of the model using a recent, unlabeled dataset.

In addition, unsupervised domain adaptation may be performed on a source model using only an unlabeled dataset of a target domain. Therefore, the proposed domain adaptation method can be utilized to build a target model even in an environment in which access to a labeled dataset of a source domain is restricted due to reasons such as security and privacy. That is, unsupervised domain adaptation to the target domain can be easily performed even in a source-free environment.

However, the effects of the present disclosure are not restricted to the one set forth herein. The above and other effects of the present disclosure will become more apparent to one of daily skill in the art to which the present disclosure pertains by referencing the claims.

According to an aspect of one or more example embodiments of the present disclosure, there is provided a method for a performance evaluation performed by at least one computing device. The method may include: obtaining a first model trained using a labeled dataset of a source domain, obtaining a second model built by performing domain adaptation to a target domain on the first model, generating a pseudo label for an evaluation dataset of the target domain using the second model, and evaluating a performance of the first model using the pseudo label, wherein the evaluation dataset is an unlabeled dataset, and the generating of the pseudo label may include adjusting an upper limit of a size constraint of adversarial noise based on a predefined factor, deriving the adversarial noise for a data sample belonging to the evaluation dataset within a range that satisfies the size constraint according to the adjusted upper limit, generating a noisy sample by reflecting the derived adversarial noise in the data sample, and generating a pseudo label for the data sample based on a predicted label of the noisy sample obtained through the second model.

In some embodiments, the domain adaptation may be performed using an unlabeled dataset of the target domain.

In some embodiments, the domain adaptation and the generating of the pseudo label may be performed without using the labeled dataset.

In some embodiments, obtaining of the second model may include monitoring a training loss calculated during a domain adaptation process, determining a time when an amount of change in the training loss is equal to or less than a reference value as an early stop time, and obtaining the second model by stopping the domain adaptation at the determined early stop time.

In some embodiments, adjusting of the upper limit of the size constraint may include adjusting a first upper limit applied to a size constraint of a first data sample belonging to the evaluation dataset, and adjusting a second upper limit applied to a size constraint of a second data sample belonging to the evaluation dataset, wherein the adjusted first upper limit may be different from the adjusted second upper limit.

In some embodiments, the predefined factor may include a first factor related to characteristics of the evaluation dataset and a second factor related to characteristics of the data sample.

In some embodiments, adjusting of the upper limit of the size constraint may include measuring predictive uncertainty of the second model for the data sample and adjusting the upper limit based on the predictive uncertainty.

In some embodiments, measuring of the predictive uncertainty may include obtaining a plurality of predicted labels by applying a drop-out technique to at least a portion of the second model and repeating prediction for the data sample, determining a class with a highest average confidence score among the plurality of predicted labels, and measuring the predictive uncertainty for the data sample based on confidence scores of the determined class included in the plurality of predicted labels, wherein values of the plurality of predicted labels may be confidence scores for each class.

In some embodiments, adjusting of the upper limit of the size constraint may include obtaining a first predicted label for the data sample through the first model, obtaining a second predicted label for the data sample through the second model, and adjusting the upper limit based on a difference between the first predicted label and the second predicted label.

In some embodiments, the difference between the first predicted label and the second predicted label may be calculated based on Jensen-Shannon divergence (JSD).

In some embodiments, adjusting of the upper limit of the size constraint may include adjusting the upper limit based on a degree of dispersion of data samples of the evaluation dataset.

In some embodiments, the data samples may be images, and the adjusting of the upper limit based on the degree of dispersion of the data samples of the evaluation dataset may include calculating a representative vale of each of the data samples based on a pixel value of each of the data samples and measuring the degree of dispersion of the data samples based on a degree of dispersion of calculated representative values.

In some embodiments, the degree of dispersion of the representative values may be a first degree of dispersion, and the measuring of the degree of dispersion of the data samples based on the degree of dispersion of the calculated representative values may include obtaining a second degree of dispersion of data samples of the labeled dataset from training history data of the labeled dataset of the source domain without accessing the labeled dataset and calculating a degree of dispersion of the data samples based on a ratio of the first degree of dispersion to the second degree of dispersion.

In some embodiments, adjusting of the upper limit of the size constraint may include adjusting the upper limit based on a number of classes of the evaluation dataset.

In some embodiments, deriving of the adversarial noise may include obtaining a first predicted label for the data sample through the second model, generating a specific noisy sample by reflecting a value of a noise parameter in the data sample, obtaining a second predicted label for the specific noisy sample through the second model, updating the value of the noise parameter in a direction to increase a difference between the first predicted label and the second predicted label and calculating the adversarial noise for the data sample based on the updated value of the noise parameter.

In some embodiments, evaluating of the performance of the first model may include predicting a label of the evaluation dataset through the first model and evaluating the performance of the first model by comparing the pseudo label and the predicted label.

According to another aspect of one or more example embodiments of the present disclosure, there is a provided performance evaluation system. The system may include one or more processors and a memory configured to store a computer program which is to be executed by the one or more processors, wherein the computer program may include instructions for performing: an operation of obtaining a first model trained using a labeled dataset of a source domain, an operation of obtaining a second model built by performing domain adaptation to a target domain on the first model, an operation of generating a pseudo label for an evaluation dataset of the target domain using the second model, and an operation of evaluating a performance of the first model using the pseudo label, wherein the evaluation dataset may be an unlabeled dataset, and the operation of generating the pseudo label may include an operation of adjusting an upper limit of a size constraint of adversarial noise based on a predefined factor, an operation of deriving the adversarial noise for a data sample belonging to the evaluation dataset within a range that satisfies the size constraint according to the adjusted upper limit, an operation of generating a noisy sample by reflecting the derived adversarial noise in the data sample, and an operation of generating a pseudo label for the data sample based on a predicted label of the noisy sample obtained through the second model.

According to another aspect of one or more example embodiments of the present disclosure, there is a provided a non-transitory computer-readable recording medium configured to store a computer program to be executed by one or more processors to perform: obtaining a first model trained using a labeled dataset of a source domain, obtaining a second model built by performing domain adaptation to a target domain on the first model, generating a pseudo label for an evaluation dataset of the target domain using the second model, and evaluating a performance of the first model using the pseudo label, wherein the evaluation dataset may be an unlabeled dataset, and the generating of the pseudo label may include adjusting an upper limit of a size constraint of adversarial noise based on a predefined factor, deriving the adversarial noise for a data sample belonging to the evaluation dataset within a range that satisfies the size constraint according to the adjusted upper limit, generating a noisy sample by reflecting the derived adversarial noise in the data sample, and generating a pseudo label for the data sample based on a predicted label of the noisy sample obtained through the second model.

### BRIEF DESCRIPTION OF THE DRAWINGS

These and/or other aspects will become apparent and more readily appreciated from the following description of the embodiments, taken in conjunction with the accompanying drawings in which:

FIGS. 1 and 2 are example diagrams schematically illustrating a performance evaluation system and its operating environment according to embodiments of the present disclosure;

FIG. 3 is an example flowchart illustrating a performance evaluation method according to embodiments of the present disclosure;

FIG. 4 is an example conceptual diagram illustrating a change in a model by unsupervised domain adaptation which can be referred to in some embodiments of the present disclosure;

FIG. 5 is an example flowchart illustrating a method of generating a pseudo label according to embodiments of the present disclosure;

FIG. 6 is an example flowchart illustrating a method of deriving adaptive adversarial noise according to embodiments of the present disclosure;

FIG. 7 is an example diagram for explaining a method of measuring a predictive uncertainty-related factor which can be used in some embodiments of the present disclosure;

FIG. 8 is an example diagram for explaining a method of measuring a domain gap-related factor which can be used in some embodiments of the present disclosure;

FIG. 9 is an example diagram for explaining a method of measuring a dispersion-related factor which can be used in some embodiments of the present disclosure;

FIG. 10 is an example flowchart illustrating a detailed process of the adversarial noise derivation operation illustrated in FIG. 6;

FIG. 11 is an example conceptual diagram for further explaining the adversarial noise derivation operation illustrated in FIG. 6;

FIGS. 12 through 14 are example diagrams for explaining various utilization examples of the performance evaluation method according to the embodiments of the present disclosure;

FIG. 15 is an example flowchart illustrating an unsupervised domain adaptation method according to embodiments of the present disclosure;

FIG. 16 illustrates an example structure of a source model which can be referred to in some embodiments of the present disclosure;

FIG. 17 is an example conceptual diagram for further explaining the reason for updating a feature extractor while freezing a predictor according to embodiments of the present disclosure;

FIG. 18 is an example diagram for explaining a loss calculation method according to embodiments of the present disclosure;

FIG. 19 is an example diagram for explaining a method of calculating a consistency loss according to embodiments of the present disclosure;

FIG. 20 is an example diagram for explaining a method of generating a pseudo label for unsupervised domain adaptation according to embodiments of the present disclosure;

FIG. 21 is an example diagram for explaining a method of calculating a consistency loss according to embodiments of the present disclosure; and

FIG. 22 illustrates an example computing device that can implement the performance evaluation system according to the embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Embodiments of the present disclosure will be described with reference to the attached drawings.

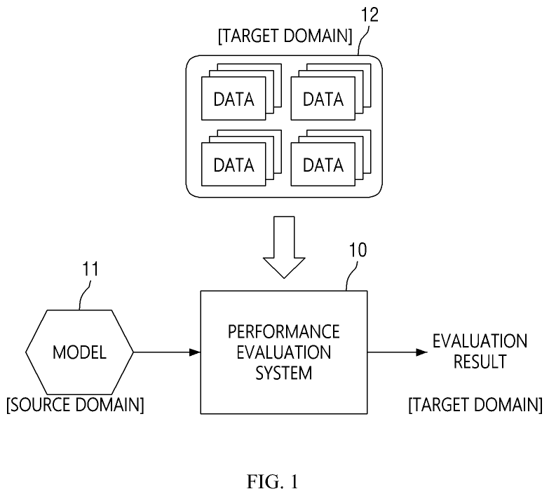

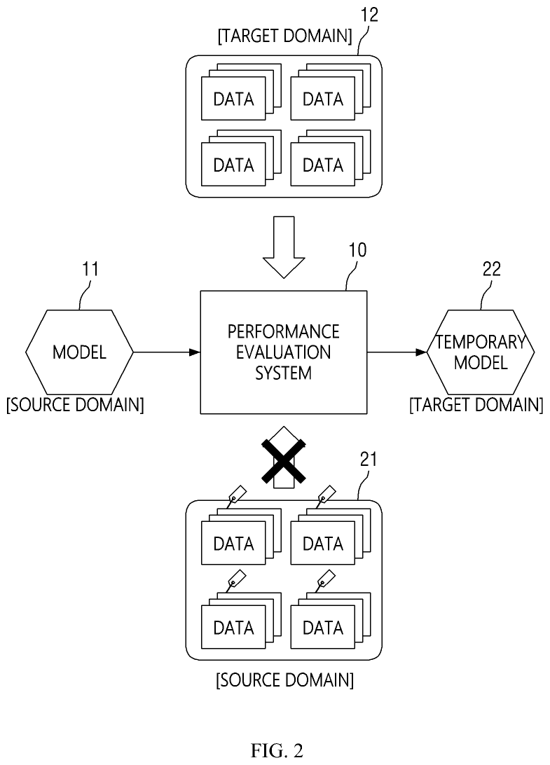

FIGS. 1 and 2 are example diagrams schematically illustrating a performance evaluation system 10 and its operating environment according to embodiments of the present disclosure.

As illustrated in FIG. 1 or 2, the performance evaluation system 10 is a system that can evaluate the performance of a model 11 of a source domain using an unlabeled dataset 12 of a target domain. That is, the performance evaluation system 10 may evaluate the performance of the model 11 belonging to the source domain (i.e., the performance for the target domain) by using the unlabeled dataset 12 of the target domain as an evaluation dataset. Here, the model 11 may be a model trained (i.e., supervised learning) using a labeled dataset (e.g., see 21 in FIG. 2) of the source domain. For ease of description, the performance evaluation system 10 will hereinafter be shortened to ‘evaluation system 10’.

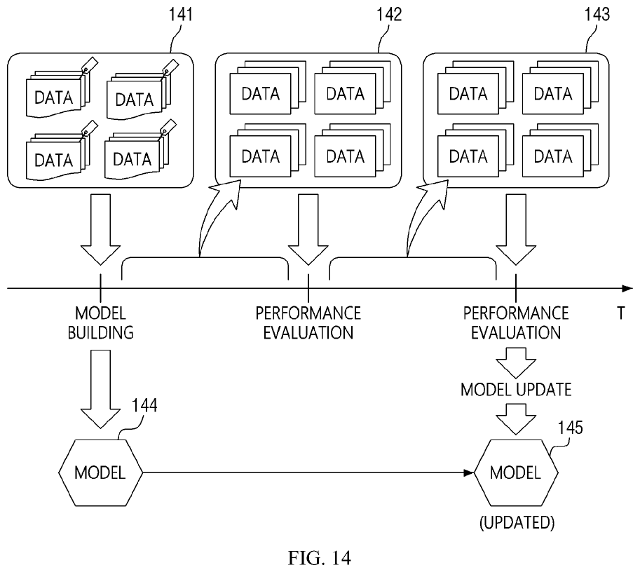

For reference, the target domain may refer to any domain having a different dataset distribution from the source domain. For example, if the distribution of a dataset changes over time, the dataset at a first time (e.g., a past time) may be a dataset belonging to the source domain, and the dataset at a second time (e.g., a recent time) may be a dataset belonging to the target domain. In addition, a model that has learned the dataset at the first time may be a model of the source domain (e.g., see FIG. 14).

In some cases, a model of the source domain may be shortened to a ‘source model’, a ‘first model’, etc., and a model of the target domain may be shortened to a ‘target model’, a ‘second model’, etc. In addition, in some cases, a dataset of the source domain may be shortened to a ‘source dataset’, and a dataset of the target domain may be shortened to a ‘target dataset’.

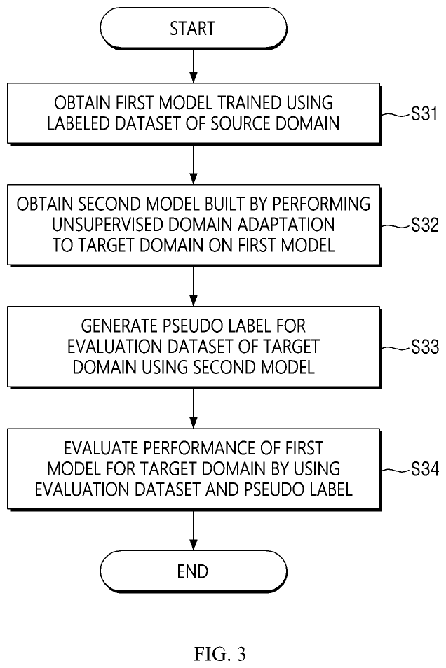

More specifically, as illustrated in FIG. 2, the evaluation system 10 may build a temporary model 22 by performing unsupervised domain adaptation to the target domain on the source model 11. Then, the evaluation system 10 may generate a pseudo label of the evaluation dataset 12 using the temporary model 22 and evaluate the performance of the source model 11 using the generated pseudo label and the evaluation dataset 12. In so doing, the performance of the source model 11 can be accurately evaluated even in an environment in which there are few labeled datasets or in an environment in which access to a labeled dataset 21 (i.e., a source dataset) used for learning (training) of the source model 11 is restricted. For example, the actual performance of the model 11 (i.e., the performance when deployed in a real environment) can be accurately evaluated using the unlabeled dataset 12 in the real environment (or domain), to which the source model 11 is to be applied, as the evaluation dataset. A specific method by which the evaluation system 10 evaluates the performance of the source model 11 will be described in more detail later with reference to FIG. 3 and subsequent drawings.

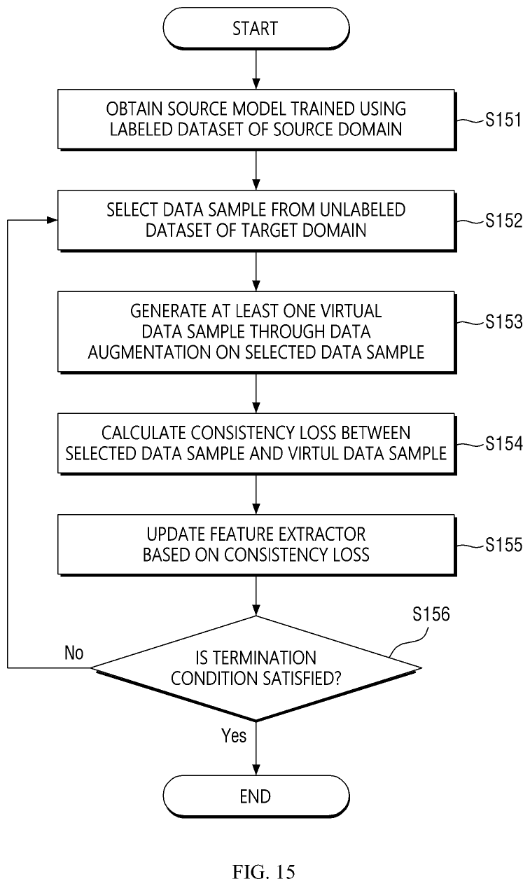

For reference, ‘unsupervised domain adaptation’ refers to a technique for performing domain adaptation using an unlabeled dataset. The concept and execution method of unsupervised domain adaptation will be already familiar to those skilled in the art, and thus a detailed description thereof will be omitted. Some examples of the unsupervised domain adaptation method will be described later with reference to FIGS. 15 through 21.

In some cases, the temporary model 22 built through unsupervised domain adaptation may be deployed and utilized in the target domain. For example, the evaluation system 10 may build a target model (e.g., 22) by performing unsupervised domain adaptation on the source model 11 using only an unlabeled dataset (e.g., 12) of the target domain without using the source dataset 21 (i.e., in a so-called ‘source-free’ manner). Then, the evaluation system 10 may place (provide) the target model (e.g., 22) in the target domain.

The evaluation system 10 described above may be implemented in at least one computing device. For example, all functions of the evaluation system 10 may be implemented in one computing device, or a first function of the evaluation system 10 may be implemented in a first computing device, and a second function may be implemented in a second computing device. Alternatively, a certain function of the evaluation system 10 may be implemented in a plurality of computing devices.

A computing device may be any device having a computing function, and an example of this device is illustrated in FIG. 22. Since the computing device is a collection of various components (e.g., a memory, a processor, etc.) interacting with each other, it may also be referred to as a ‘computing system’ in some cases. In addition, the term ‘computing system’ may encompass the concept that it is a collection of a plurality of computing devices interacting with each other.

Until now, the evaluation system 10 and its operating environment according to the embodiments of the present disclosure have been roughly described with reference to FIGS. 1 and 2. Hereinafter, various methods that can be performed by the above-described evaluation system 10 will be described with reference to FIG. 3 and subsequent drawings.

For ease of understanding, the description will be continued based on the assumption that all steps/operations of the methods to be described later are performed by the above-described evaluation system 10. Therefore, when the subject of a specific step/operation is omitted, it may be understood that the step/operation is performed by the evaluation system 10. However, in a real environment, some steps of the methods to be described later may also be performed by another computing device. For example, unsupervised domain adaptation on a given model (e.g., 11 in FIG. 1) may also be performed by another computing device.

In addition, for more ease of understanding, the description will be continued based on the assumption that a first model (e.g., 11 in FIG. 1), whose performance is to be evaluated, and a second model (e.g., 22 in FIG. 2) are models that predict and classify class labels (i.e., models that output confidence scores for each class). In addition, the description will be continued by changing reference numerals indicating the first model and the second model.

FIG. 3 is an example flowchart schematically illustrating a performance evaluation method according to embodiments of the present disclosure. However, this is only an exemplary embodiment for achieving the objectives of the present disclosure, and some operations can be added or deleted as needed.

As illustrated in FIG. 3, the performance evaluation method according to the embodiments may start with operation S31 in which a first model learned (trained) using a labeled dataset (i.e., a training dataset) of a source domain is obtained. Here, the first model may refer to a source model (e.g., 11 in FIG. 1) whose performance is to be evaluated.

In operation S32, a second model built by performing unsupervised domain adaptation to a target domain on the first model may be obtained. Here, the second model may refer to a temporary model (e.g., 22 in FIG. 2) built to generate a pseudo label for an evaluation dataset. For example, the evaluation system 10 may build the second model by performing adaptation to the target domain (e.g., additional learning) on the first model using an unlabeled dataset of the target domain (e.g., an evaluation dataset or a dataset different from the evaluation dataset). However, a specific method of performing unsupervised domain adaptation may vary according to embodiments.

In some embodiments, the second model may be built by additionally training the first model based on a consistency loss between a data sample belonging to an unlabeled dataset of the target domain and a virtual data sample generated from the data sample. In this case, the second model can be built without using a labeled dataset (i.e., a training dataset) of the first model (i.e., in a source-free manner). These embodiments will be described in detail later with reference to FIG. 15 through FIG. 21.

In some embodiments, the second model may be built using an unsupervised domain adaptation technique widely known in the art to which the present disclosure pertains.

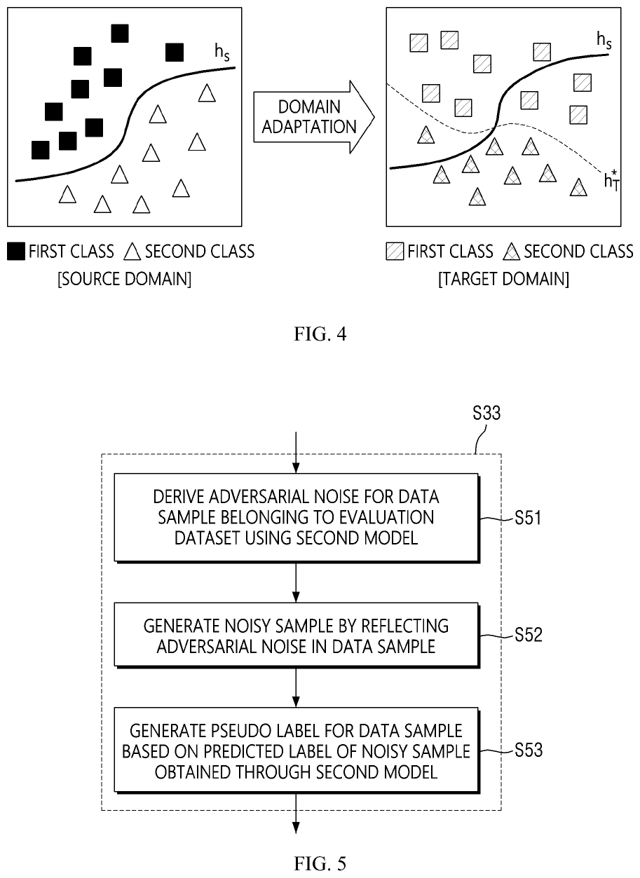

FIG. 4 is an example conceptual diagram illustrating a change in a model by unsupervised domain adaptation. FIG. 4 illustrates a case where a first model is a source domain's model that performs binary classification and where a second model is built by adapting the first model to a target domain. In addition, in FIG. 4, a curve represented by a solid line (see h_{S}) is a classification curve of the first model (or a decision boundary of a source dataset), and a curve represented by a dotted line (see h*_{T}) is a classification curve of the second model (or a decision boundary of a target dataset).

In some embodiments, the evaluation system 10 may perform early stopping to reduce time and computing costs required for unsupervised domain adaptation. Specifically, the evaluation system 10 may monitor a training loss calculated during the unsupervised domain adaptation process and determine an early stop time based on the amount of change in the training loss. For example, the evaluation system 10 may determine a time when the amount of change in the training loss is equal to or less than a reference value as the early stop time. Next, the evaluation system 10 may obtain the second model by stopping the unsupervised domain adaptation at the determined early stop time. The inventors of the present disclosure confirmed through experiments that the second model obtained through early stopping had a fairly minor effect on the accuracy of performance evaluation of the first model.

In the above embodiments, the amount of change in the training loss can be calculated in various ways. For example, the evaluation system 10 may calculate the amount of change in the training loss based on the change in slope of a training loss curve, the average of the training loss (i.e., average per unit section), or the amount of change in exponential moving average (EMA). However, the scope of the present disclosure is not limited thereto.

Referring back to FIG. 3, in operation S33, a pseudo label for an evaluation dataset of the target domain may be generated using the second model. Here, the evaluation dataset corresponds to an unlabeled dataset.

In some embodiments of the present disclosure, the evaluation system 10 may adaptively generate adversarial noise for data samples of the evaluation dataset in consideration of the characteristics of the evaluation dataset (or the target domain) and the characteristics of the individual data samples and may generate a pseudo label for each data sample by using the adversarial noise. Accordingly, the pseudo label can be generated more accurately. This will be described in detail later with reference to FIGS. 5 through 11.

In operation S34, the performance of the first model for the target domain may be evaluated using the evaluation dataset and the pseudo label. For example, the evaluation system 10 may obtain a predicted label for each data sample belonging to the evaluation dataset by inputting each data sample to the first model and evaluate the performance of the first model by comparing the obtained predicted label with the pseudo label of the data sample. In a more specific example, the evaluation system 10 may compare a class label (e.g., a predicted class, a confidence score for each class, etc.) predicted through the first model with the pseudo label to evaluate the accuracy of the first model (e.g., evaluate a concordance rate between a predicted class and a class recorded in the pseudo label as the accuracy of the first model for the target domain).

For reference, a data sample may refer to one unit of data input to a model (e.g., the first model). In the art to which the present disclosure pertains, ‘sample’ or ‘data sample’ may also be referred to as ‘example,’ ‘instance,’ ‘observation,’ ‘record,’ ‘unit data,’ and ‘individual data.’

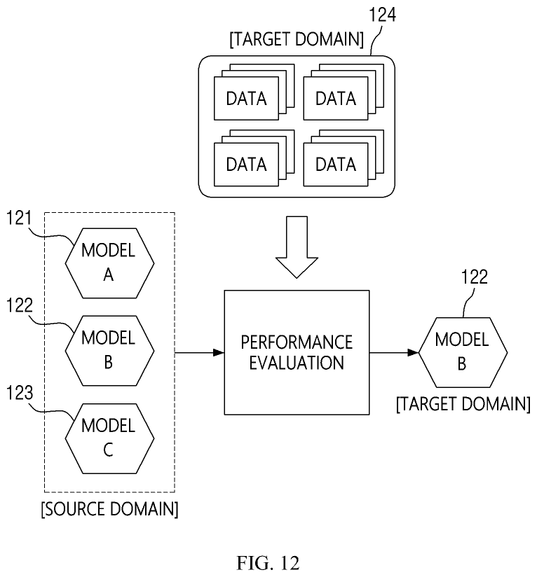

The performance evaluation result obtained according to the above-described method may be utilized for various purposes. For example, the evaluation system 10 may utilize the performance evaluation result to select a source model suitable for the target domain or to determine an update time (or performance degradation time) of the first model (e.g., in a case where the first model is a model in use (service) in the target domain). These utilization examples will be described in more detail later with reference to FIGS. 12 through 14.

Until now, the performance evaluation method according to the embodiments of the present disclosure has been described with reference to FIGS. 3 and 4. According to the above description, a second model (i.e., a temporary model in a target domain) may be built by performing unsupervised domain adaptation to the target domain on a first model (i.e., a source model whose performance is to be evaluated), and a pseudo label for an evaluation dataset may be generated using the second model. Accordingly, the performance of the first model for the target domain can be easily evaluated even in an environment in which only unlabeled datasets exist in the target domain or in an environment in which access to training datasets of the first model is restricted. For example, the actual performance of the first model (i.e., the performance when deployed in a real environment) can be easily evaluated by evaluating the performance of the first model using an unlabeled dataset generated in the real environment. Further, time and human costs required for labeling the evaluation dataset can be reduced.

A method of generating a pseudo label according to embodiments of the present disclosure will now be described with reference to FIGS. 5 through 11.

FIG. 5 is an example flowchart illustrating a method of generating a pseudo label according to embodiments of the present disclosure. However, this is only an exemplary embodiment for achieving the objectives of the present disclosure, and some operations can be added or deleted as needed.

As illustrated in FIG. 5, the method according to the embodiments may start with operation S51 in which adversarial noise for a data sample belonging to an evaluation dataset is derived using a second model. Here, the adversarial noise refers to noise that can increase (e.g., maximize) a difference in predicted value (i.e., a difference in predicted label) between the data sample and a noisy sample (i.e., a sample obtained by reflecting the adversarial noise in the data sample).

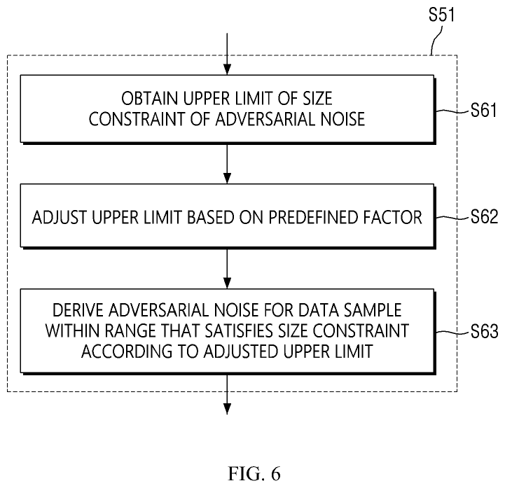

In some cases, the ‘adversarial noise’ may be referred to as ‘adversarial disturbance/perturbation’, and the ‘noisy sample’ may be referred to as a ‘transformed/deformed sample’ or a ‘disturbance/perturbation sample.’ For better understanding, a method of deriving the adversarial noise will be described in detail with reference to FIGS. 6 through 11.

FIG. 6 is an example flowchart illustrating a method of deriving adversarial noise according to embodiments of the present disclosure. However, this is only an exemplary embodiment for achieving the objectives of the present disclosure, and some operations can be added or deleted as needed.

As illustrated in FIG. 6, the method of deriving adversarial noise according to the embodiments relates to a method of adaptively deriving adversarial noise for each data sample based on a factor defined to reflect the characteristics of an evaluation dataset (or a target domain) and/or the characteristics of the individual data sample. Experimentally, there is a minimum limit of model accuracy estimation error which can be achieved when the adversarial noise is uniformly set to the same size regardless of the characteristics of the data samples. However, if the size of the adversarial noise is set variably according to the characteristics of the data samples, the estimation error can be further reduced. For example, the adversarial noise may be derived in a way that more strongly disturbs data samples located close to a decision boundary of a second model, thereby further reducing erroneous agreement between a source model's wrong prediction for evaluation data and a pseudo label's prediction. In other words, the probability of erroneous agreement between the predictions of the pseudo label and the source model may be lowered, thereby reducing estimation distortion of model accuracy, and as a result, guaranteeing ‘relative’ accuracy of performance evaluation.

Specifically, in operation S61, an upper limit of a size constraint of the adversarial noise may be obtained. For example, the evaluation system 10 may obtain a default upper limit (e.g., see ‘ε₀’ in Equation 1) that is equally applied to a plurality of data samples.

In operation S62, the upper limit (e.g., the default upper limit) of the size constraint may be adjusted based on a predefined factor. Here, the predefined factor is a scale factor for adjusting the size of the upper limit and may include, for example, a factor related to the characteristics of an evaluation dataset (or a target domain), a factor related to the characteristics of an individual data sample, etc. However, the scope of the present disclosure is not limited thereto. Various factors that can be used for the size constraint of the adversarial noise and methods of measuring (calculating) the factors will now be described.

First, a first factor concerns the predictive uncertainty of a data sample. The first factor can be understood as a factor related to the characteristics of an individual data sample (i.e., a sample-level factor) and a factor used to more strongly disturb a data sample located close to the decision boundary of the second model.

A specific method of measuring the predictive uncertainty (or the value of the first factor) of a data sample can be designed in various ways.

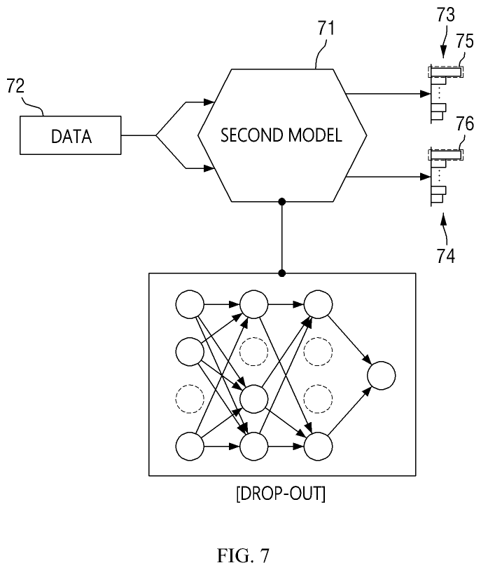

For example, as illustrated in FIG. 7, the evaluation system 10 may measure the predictive uncertainty of a data sample using a drop-out technique (e.g., see dotted line nodes). Specifically, the evaluation system 10 may obtain a plurality of predicted labels 73 and 74 by applying a drop-out technique to at least a portion of a second model 71 and repeating prediction (inference) for a data sample 72. Here, values of the predicted labels 73 and 74 correspond to confidence scores for each class (i.e., a probability distribution for predefined classes). For reference, FIG. 7 assumes that the second model 71 is a model (e.g., a neural network) to which the drop-out technique can be applied and that two predictions are performed. Next, the evaluation system 10 may determine a class with a highest average confidence score among the predicted labels 73 and 74 and measure (calculate) predictive uncertainty for the data sample 72 based on confidence scores 75 and 76 of the class. For example, the evaluation system 10 may measure (calculate) the predictive uncertainty for the data sample 72 based on the standard deviation, variance, etc. of the confidence scores 75 and 76 of the class (e.g., the standard deviation is used as uncertainty, and the higher the standard deviation, the higher the predictive uncertainty calculated). According to the current example, the predictive uncertainty for the data sample 72 can be accurately measured using the standard deviation, etc. of confidence scores of a class with the highest prediction reliability.

In another example, the evaluation system 10 may generate at least one virtual data sample from a data sample through a data augmentation technique. In addition, the evaluation system 10 may measure the predictive uncertainty of the data sample by analyzing a difference between a predicted label of the data sample obtained through the second model and a predicted label of at least one virtual data sample (e.g., the predictive uncertainty is measured in a similar way to the previous example).

In another example, the evaluation system 10 may calculate an entropy value based on a confidence score for each class of a data sample output from the second model and measure the predictive uncertainty of the data sample based on the entropy value.

In another example, the evaluation system 10 may measure the predictive uncertainty of a data sample based on various combinations of the examples described above. For example, the evaluation system 10 may calculate the final predictive uncertainty of a data sample based on the weighted sum of predictive uncertainties measured by each of the above-described examples.

When the predictive uncertainty of a data sample is measured according to the above-described examples, the evaluation system 10 may adjust the upper limit of the size constraint to be applied to the adversarial noise of the data sample based on the measured value. For example, the evaluation system 10 may further raise the upper limit of the size constraint as the predictive uncertainty increases (or when the predictive uncertainty is equal to or higher than a reference value), and in the opposite case, may maintain the upper limit or further lower the upper limit.

Next, a second factor concerns a distribution difference (or a domain gap) between a source dataset (or a source domain) and an evaluation dataset (or a target domain or a target dataset). The second factor may be used as a bias term for making up for the inaccuracy of the first factor (e.g., if the distribution difference between the two datasets is large, the accuracy of domain adaptation may decrease, resulting in a reduction in the prediction accuracy of the second model. That is, the larger the distribution difference between the two datasets, the more inaccurately the predictive uncertainty of a data sample may be measured. Therefore, the distribution difference may be used as a bias term of the first factor). In addition, the second factor may be a factor related to the characteristics of an individual data sample or a factor related to the characteristics of the evaluation dataset (i.e., dataset/domain-level characteristics) (e.g., may be a dataset-level factor if a difference in predicted label is calculated for each data sample and the calculated differences are aggregated).

A specific method of measuring the distribution difference (or the value of the second factor) between the source dataset and the evaluation dataset (or the target dataset) can be designed in various ways.

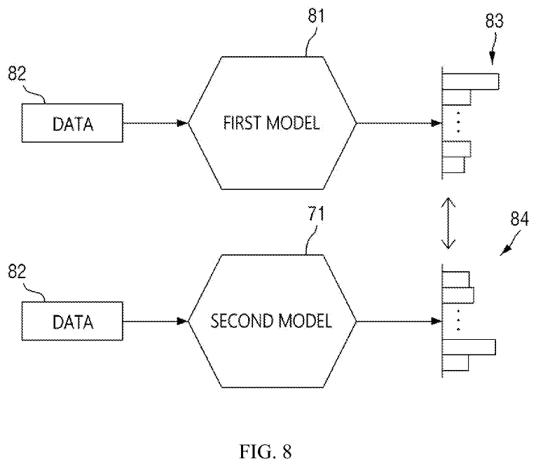

For example, as illustrated in FIG. 8, the evaluation system 10 may obtain a first predicted label 83 for a data sample 82 through a first model 81 and obtain a second predicted label 84 for the data sample 82 through a second model 71. Then, the evaluation system 10 may calculate the value of the second factor based on a difference between the first predicted label 83 and the second predicted label 84. This method can be understood as indirectly (or in a roundabout way) measuring a distribution difference between a source dataset and an evaluation dataset (or a target dataset) in an environment in which the source dataset is not accessible. The difference between the first predicted label 84 and the second predicted label 85 may be calculated based on, for example, Jensen-Shannon divergence (JSD) or Jensen-Shannon (JS) distance, but the scope of the present disclosure is limited thereto. For reference, the JSD has the advantage of ensuring computational convenience because it has symmetry and is easy to normalize. The concepts and specific formulas of the JSD and the JS distance will be already familiar to those skilled in the art, and thus a description thereof will be omitted.

When the value of the second factor for a data sample is measured according to the above-described examples, the evaluation system 10 may adjust the upper limit of the size constraint to be applied to the adversarial noise of the data sample based on the measured value. For example, the evaluation system 10 may further raise the upper limit of the size constraint as the value of the second factor increases (or when the value of the second factor is equal to or higher than a reference value), and in the opposite case, may maintain the upper limit or further lower the upper limit.

Next, a third factor concerns the degree of dispersion (or density) of an evaluation dataset (or a target dataset). The third factor can be understood as a factor related to the characteristics of the evaluation dataset (i.e., dataset-level characteristics).

A specific method of measuring (calculating) the degree of dispersion of an evaluation dataset (i.e., the degree to which data samples are dispersed) can be designed in various ways.

For example, the evaluation system 10 may extract a representative value from each of data samples belonging to an evaluation dataset and measure the degree of dispersion of the evaluation dataset based on the standard deviation, variance, etc. of the representative values. In some cases, the evaluation system 10 may also measure the degree of dispersion of a source dataset (or another target dataset) and use a ratio (i.e., relative degree of dispersion) of the degree of dispersion of the evaluation dataset to the degree of dispersion of the source dataset (or another target dataset) as the value of the third factor.

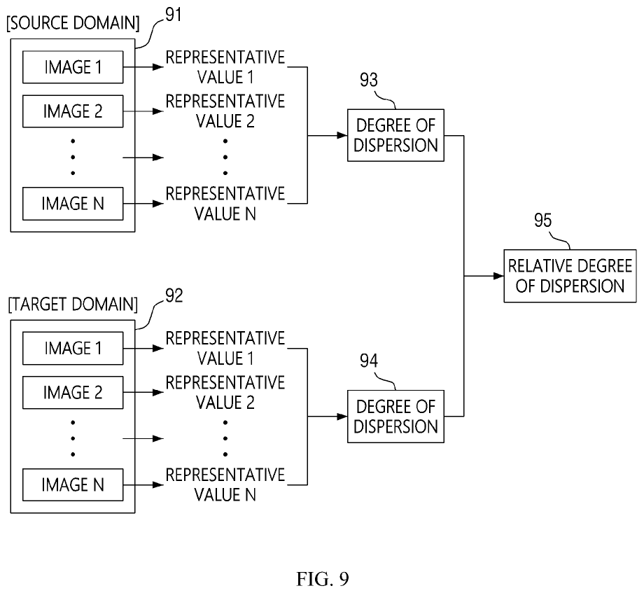

In a more specific example, when data samples of an evaluation dataset 92 are images, the evaluation system 10 may calculate a relative degree of dispersion 95 of the evaluation dataset 92 with respect to a source dataset 91 in a way illustrated in FIG. 9. Specifically, the evaluation system 10 may extract a representative value (e.g., an average pixel value) from each of image samples of the source dataset 91 and calculate a degree of dispersion 93 (hereinafter, referred to as a ‘first degree of dispersion’) of the source dataset 91 based on the standard deviation, variance, etc. of the representative values. Here, the evaluation system 10 may calculate the degree of dispersion for each color channel (e.g., R, G and B channels) and calculate the first degree of dispersion 93 of the source dataset 91 by aggregating the calculated degrees of dispersion. Next, the evaluation system 10 may calculate a degree of dispersion 94 (hereinafter, referred to as a ‘second degree of dispersion’) of the evaluation dataset 92 in the same way. Next, the evaluation system 10 may calculate the relative degree of dispersion 95 of the evaluation dataset 93 based on a ratio of the two degrees of dispersion 93 and 94 and use the relative degree of dispersion 95 as the value of the third factor.

For reference, in an environment in which access to the source dataset 91 (e.g., a labeled dataset) is restricted, the evaluation system 10 may calculate the first degree of dispersion 93 illustrated in FIG. 9 by using training history data of a first model which has learned the source dataset 91. In other words, since the training history data of the first model includes the results of preprocessing operations (e.g., normalization operations using average, standard deviation, etc.) on the image samples of the source dataset 91, the evaluation system 10 can obtain representative values for the image samples from this training history data without accessing the source dataset 91. Then, the evaluation system 10 can calculate the first degree of dispersion 93 using the obtained representative values.

When the degree of dispersion (e.g., the relative degree of dispersion) of an evaluation dataset is measured according to the above-described examples, the evaluation system 10 may adjust the upper limit of the size constraint to be applied to the adversarial noise of a corresponding data sample based on the measured value. For example, the evaluation system 10 may further raise the upper limit of the size constraint as the degree of dispersion increases (or when the degree of dispersion is equal to or higher than a reference value), and in the opposite case, may maintain the upper limit or further lower the upper limit.

For reference, the upper limit is further raised as the degree of dispersion of the evaluation dataset increases because a higher degree of dispersion means a larger distance between data samples (points) in a data space and thus the data samples need to be moved (disturbed) more.

Finally, a fourth factor concerns class complexity. The fourth factor can be understood as a factor related to the characteristics of an evaluation dataset (i.e., dataset/domain-level characteristics).

A specific method of measuring class complexity can be designed in various ways.

For example, the evaluation system 10 may measure the class complexity of an evaluation dataset (or a second model, etc.) based on the number of classes defined in the evaluation dataset. For example, the evaluation system 10 may calculate the class complexity by taking the log (e.g., natural log) or square root of the number of classes. However, the scope of the present disclosure is not limited thereto.

When the class complexity of the evaluation dataset is measured according to the above-described examples, the evaluation system 10 may adjust the upper limit of the size constraint to be applied to the adversarial noise of a corresponding data sample based on the measured value. For example, the evaluation system 10 may further raise the upper limit of the size constraint as the value of the fourth factor increases (or when the value of the fourth factor is equal to or higher than a reference value), and in the opposite case, may maintain the upper limit or further lower the upper limit.

For reference, the upper limit is further raised as the class complexity increases because high class complexity usually means a large number of classes, and as the number of classes increases, the size of a data space is highly likely to increase exponentially (e.g., a large data space means a large distance between data samples).

According to some embodiments of the present disclosure, the evaluation system 10 may adjust the upper limit of the size constraint to be applied to the adversarial noise of a data sample based on a combination of the various factors described above. For example, the evaluation system 10 may adjust the upper limit of the size constraint according to Equation 1 below.

$$ε = {ε}_{0} {C}_{cls} {C}_{den} ( {C}_{unc} + {C}_{div} ) , \qquad ( 1 )$$

where ‘ε’ is an adjusted upper limit, and ‘co’ is a default upper limit. In addition, ‘C_{unc}’, ‘C_{div}’, ‘C_{den}’ and ‘C_{cls}’ are the first factor, the second factor, the third factor, and the fourth factor described above, respectively. Equation 1 uses the second factor as a bias term of the first factor, and the range of each factor value can be set in various ways.

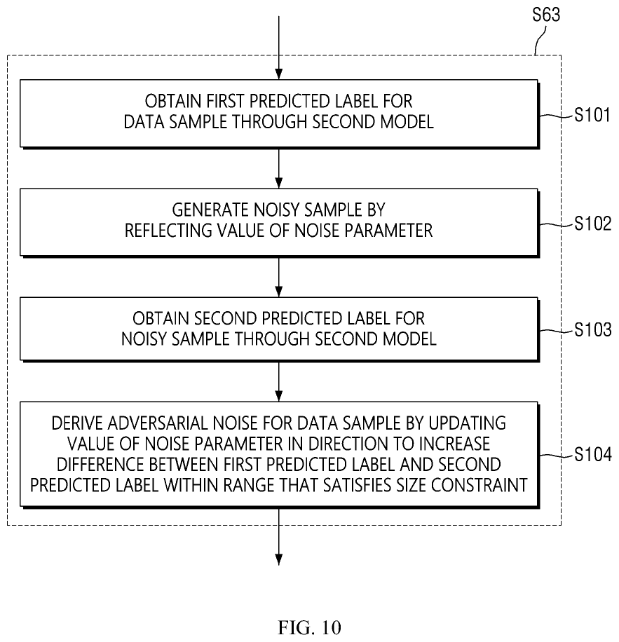

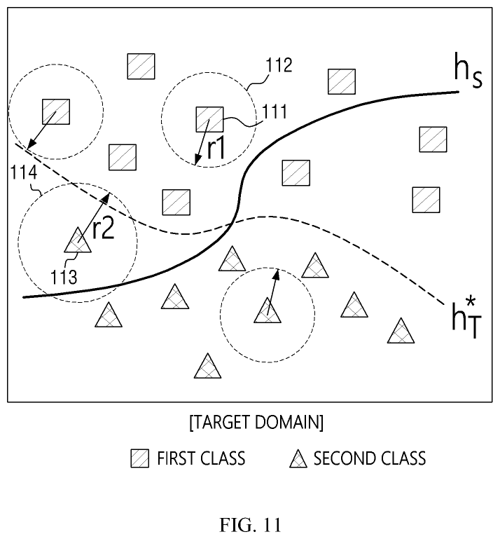

Referring back to FIG. 6, in operation S63, adversarial noise for a data sample may be derived within a range that satisfies the size constraint according to the adjusted upper limit. Specifically, as illustrated in FIG. 10, the evaluation system 10 may derive adversarial noise for a data sample by updating a value of a noise parameter in a direction to increase (e.g., maximize) a difference between a predicted label of the data sample and a predicted label of a noisy sample (e.g., a data sample in which the value of the noise parameter is reflected) obtained through the second model (e.g., by updating the value of the noise parameter through error backpropagation) (operations S101 through S104). Here, the evaluation system 10 may assign a predetermined initial value (e.g., a random value) to the noise parameter and update the value of the noise parameter within a range that satisfies the size constraint according to the adjusted upper limit. Then, the evaluation system 10 may determine the updated value of the noise parameter as the adversarial noise of the data sample.

In the above case, as illustrated in FIG. 11, values of noise parameters (see r1 and r2) may be updated in a direction to position data samples (e.g., 111 and 113) close to (or beyond) a decision boundary (see h*T). As a result, the data samples (e.g., 111 and 113) may be transformed into noisy samples located closer to (or beyond) the decision boundary (see h*r) of the second model.

For reference, in FIG. 11, the radius of a circle (see a dotted line) having a data sample (e.g., 111) as its center represents a size constraint for a noise parameter (e.g., r1). As illustrated, an upper limit (see 112) applied to the size constraint of the data sample 111 may be different from an upper limit (see 114) applied to a size constraint applied to the data sample 113. This is because the upper limit is adjusted for each data sample based on various factors. That is, the evaluation system 10 may adjust a first upper limit applied to a size constraint of a first data sample belonging to an evaluation dataset based on a predefined factor and adjust a second upper limit applied to a size constraint of a second data sample. In this case, the adjusted first upper limit may be different from the adjusted second upper limit. FIG. 11 illustrates a case where the upper limit of the data sample 113 located close to the decision boundary (see h*_{T}) of the second model is adjusted to a greater value than that of the data sample 111 located further away.

If the second model is a classification model, a value of a predicted label corresponds to a confidence score for each class (i.e., a probability distribution for each class). Therefore, a difference between the two predicted labels may be calculated based on, for example, Kullback-Leibler divergence. However, the scope of the present disclosure is not limited thereto.

The adversarial noise derivation process described so far can be summarized into Equation 2 below.

$${r}_{aap} = {arg max KL}_{δ s . t . {\vert δ \vert}_{2} \leq ε ,} {( {h}_{T} ( x ) ‖ {h}_{T} ( x + δ ) )}_{ε = {ε}_{0} {C}_{cls} {C}_{den} ( {C}_{unc} + {C}_{div} )} , \qquad ( 2 )$$

where ‘rₐₐₚ’ is adversarial noise of data sample ‘x’, and ‘δ’ is a noise parameter. In addition, ‘h_{T}’ is a second model, and ‘KL’ is Kullback-Leibler divergence (KLD).

Referring back to FIG. 5, in operation S52, a noisy sample may be generated by reflecting (e.g., adding) the adversarial noise in the data sample.

In operation S53, a pseudo label for the data sample may be generated based on a predicted label of the noisy sample obtained through the second model. For example, the evaluation system 10 may designate the predicted label of the noisy sample as the pseudo label of the data sample. For another example, the evaluation system 10 may generate a pseudo label by further performing a predetermined operation on the predicted label of the noisy sample.

Until now, the method of generating a pseudo label according to the embodiments of the present disclosure has been described with reference to FIGS. 5 through 11. According to the above description, a pseudo label for an evaluation dataset may be generated without using a labeled dataset of a first model. In addition, a pseudo label of a data sample may be generated based on a predicted label of a noisy sample generated by reflecting adaptive adversarial noise. By using the pseudo label generated in this way, it is possible to greatly improve the accuracy of performance evaluation for the first model. This may be understood from Tables 1 and 2 below.

Various utilization examples of the above-described performance evaluation method will now be described with reference to FIGS. 12 through 14.

FIG. 12 is a diagram for explaining a utilization example of the performance evaluation method according to the embodiments of the present disclosure.

As illustrated in FIG. 12, the above-described performance evaluation method may be utilized to select a source model 122 to be applied (deployed) to a target domain from among a plurality of source models 121 through 123 belonging to the same source domain. Here, the source models 121 through 123 may be models having different characteristics, for example, models having different types, structures, and numbers of weight parameters. FIG. 12 illustrates a case where the source model 122 (B) among the three source models 121 through 123 is selected as a model to be applied to the target domain.

For example, the evaluation system 10 may perform performance evaluation on each of the source models 121 through 123 using an unlabeled dataset 124 of the target domain and may select a source model 122 (e.g., a model with the best performance) to be applied to the target domain based on the evaluation result. In this case, the source model 122 having the most suitable characteristics for the target domain among the source models 121 through 123 having various characteristics can be accurately selected as a model to be applied to the target domain.

In addition, the evaluation system 10 may build a target model from the selected source model 122 through a process of performing unsupervised domain adaptation on the selected source model 122 or a process of obtaining a labeled dataset and performing additional learning. Then, the evaluation system 10 may provide a service in the target domain using the target model or may provide the built target model to a separate service system.

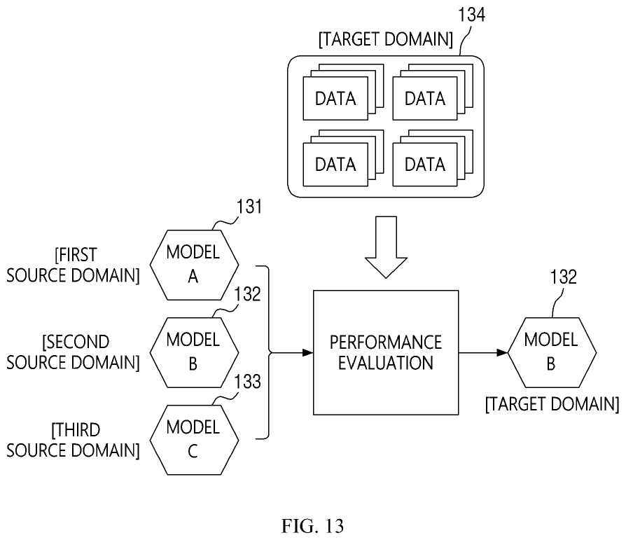

FIG. 13 is a diagram for explaining a utilization example of the performance evaluation method according to the embodiments of the present disclosure. For clarity of the present disclosure, any description overlapping that of the previous embodiments will be omitted.

As illustrated in FIG. 13, the above-described performance evaluation method may be utilized to select a source model 132 to be applied (deployed) to a target domain from among a plurality of source models 131 through 133. Here, the source models 131 through 133 may be models belonging to different source domains. FIG. 13 illustrates a case where the source model 132 (B) among the three source models 131 through 133 is selected as a model to be applied to the target domain.

For example, the evaluation system 10 may perform performance evaluation on each of the source models 131 through 133 using an unlabeled dataset 134 of the target domain and may select a source model 132 (e.g., a model with the best performance) to be applied to the target domain based on the evaluation result. In this case, the model 132 of a domain having the highest relevance to the target domain among various source domains can be accurately selected as a model to be applied to the target domain.

FIG. 14 is a diagram for explaining a utilization example of the performance evaluation method according to the embodiments of the present disclosure.

As illustrated in FIG. 14, the above-described performance evaluation method may be utilized to determine an update time (or performance degradation time) of a model 144.

Specifically, it is assumed that the model 114 has been built using a labeled dataset 141. In this case, the evaluation system 10 may repeatedly evaluate the performance of the model 144 using recently generated unlabeled datasets 142 and 143. For example, the evaluation system 10 may evaluate the performance of the model 144 periodically or non-periodically.

When the evaluated performance does not satisfy a predetermined condition (e.g., when the accuracy of the model 144 is equal to or less than a reference value), the evaluation system 10 may determine that the model 144 needs to be updated.

In addition, the evaluation system 10 may update the model 144 using various methods such as unsupervised domain adaptation, additional learning using a labeled dataset, and model rebuilding using a labeled dataset. Furthermore, the evaluation system 10 may provide a service in a corresponding domain using the updated model 145 or may provide the updated model 145 to a separate service system.

In the current utilization example, the model 144 before being updated may be understood as corresponding to the source model (or the first model) described above.

According to the above description, the update time of the model 144 can be accurately determined. In addition, even if the distribution of an actual dataset changes over time, the service quality of the model 144 or 145 can be continuously guaranteed through the update process.

Until now, various utilization examples of the performance evaluation method according to the embodiments of the present disclosure have been described with reference to FIGS. 12 through 14. Hereinafter, an unsupervised domain adaptation method according to embodiments of the present disclosure will be described with reference to FIGS. 15 through 21.

FIG. 15 is an example flowchart illustrating an unsupervised domain adaptation method according to embodiments of the present disclosure. However, this is only an exemplary embodiment for achieving the objectives of the present disclosure, and some operations can be added or deleted as needed.

As illustrated in FIG. 15, the unsupervised domain adaptation method according to the embodiments may start with operation S151 in which a source model trained (i.e., supervised learning) using a source dataset (i.e., a labeled dataset of a source domain) is obtained. A specific method of training the source model may be any method.

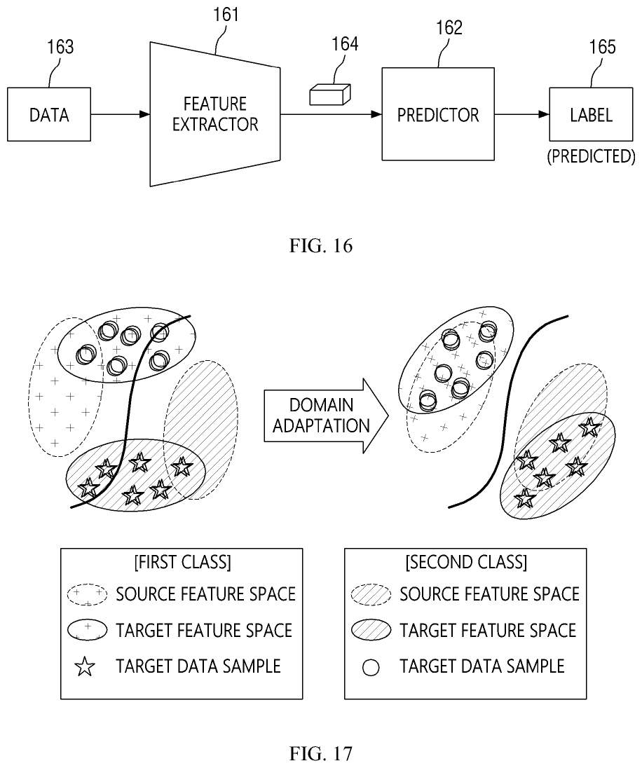

An example structure of the source model is illustrated in FIG. 16. For ease of understanding, the structure and operation of the source model will now be briefly described.

As illustrated in FIG. 16, the source model may be configured to include a feature extractor 161 and a predictor 162. In some cases, the source model may further include other modules.

The feature extractor 161 may refer to a module that extracts a feature 164 from an input data sample 163. The feature extractor 161 may be implemented as, for example, a neural network layer and in some cases may be referred to as a ‘feature extraction layer’, an ‘encoder’, etc. For example, if the feature extractor 161 is a module that extracts a feature from an image, it may be implemented as a convolutional neural network (or layer). However, the scope of the present disclosure is not limited thereto.

Next, the predictor 162 may refer to a module that predicts a label 165 of the data sample 163 from the extracted feature 164. The predictor 162 may be understood as a kind of task-specific layer, and a detailed structure of the predictor 162 may vary according to task. In addition, the format and value of the label 165 may vary according to task. Examples of the task may include classification, regression, and semantic segmentation which is a kind of classification task. However, the scope of the present disclosure is not limited by these examples.

The predictor 162 may also be implemented as, for example, a neural network layer and in some cases may be referred to as a ‘prediction layer’, an ‘output layer’, a ‘task-specific layer’, etc. For example, if the predictor 162 is a module that outputs class classification results (e.g., a confidence score for each class), it may be implemented based on a fully-connected layer. However, the scope of the present disclosure is not limited thereto.

For ease of understanding, the description will be continued based on the assumption that the source model is configured as illustrated in FIG. 16.

Referring back to FIG. 15, in operation S152, a data sample may be selected from a target dataset (i.e., an unlabeled dataset of a target domain). The data sample can be selected in any way. For example, the evaluation system 10 may select a data sample in a random manner or may select a data sample in a sequential manner. If learning is performed on a batch-by-batch basis, the evaluation system 10 may select a number of data samples corresponding to the batch size and configure the selected data samples as one batch.

In operation S153, at least one virtual data sample may be generated through data augmentation on the selected data sample. The number of virtual data samples generated may vary, and the data augmentation technique (method) may also vary according to the type, domain, etc. of data.

In operation S154, a consistency loss between the selected data sample and the virtual data sample may be calculated. However, a specific method of calculating the consistency loss may vary according to embodiments.

In some embodiments, a feature-related consistency loss (hereinafter, referred to as a ‘first consistency loss’) may be calculated using a feature extractor of the source model. The first consistency loss may be used to additionally train the feature extractor to extract similar features from similar data belonging to the target domain. In other words, since the virtual data sample is derived from the selected data sample, the two data samples can be viewed as similar data. Therefore, if the feature extractor is additionally trained to extract similar features from the two data samples, it may be trained to extract similar features from similar data (e.g., data of the same class) belonging to the target domain. The first consistency loss may be calculated based on a difference between a feature of the selected data sample and a feature of the virtual data sample. This will be described later with reference to FIG. 16.

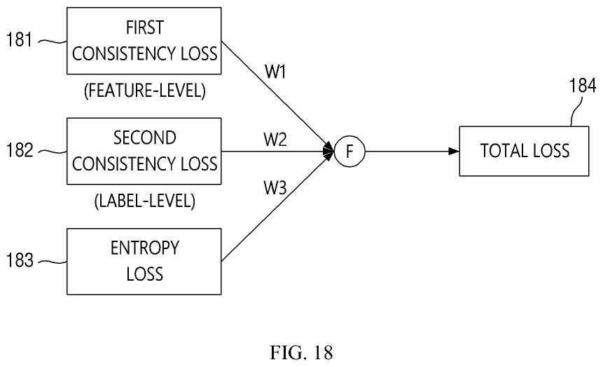

In some embodiments, a label-related consistency loss (hereinafter, referred to as a ‘second consistency loss’) may be calculated using the feature extractor and predictor of the source model. The second consistency loss may be used to additionally train the feature extractor to align a feature space (or distribution) of the target dataset with a feature space (or distribution) of the source dataset. That is, the second consistency loss may be used to align the distribution of the target dataset with the distribution of the source dataset, thereby converting the source model into a model suitable for the target domain. The second consistency loss may be calculated based on a difference between a pseudo label of the selected data sample and a predicted label of the virtual data sample. This will be described later with reference to FIGS. 17 and 18.

In some embodiments, a consistency loss may be calculated based on a combination of the above embodiments. For example, the evaluation system 10 may calculate a total consistency loss by aggregating the first consistency loss and the second consistency loss based on predetermined weights. Here, a weight assigned to the first consistency loss may be less than or equal to a weight assigned to the second consistency loss. In this case, it has been experimentally confirmed that the performance of a target model is further improved.

In operation S155, the feature extractor may be updated based on the consistency loss. For example, in a state where the predictor is frozen (or fixed), the evaluation system 10 may update a weight of the feature extractor in a direction to reduce the consistency loss (i.e., the predictor is not updated). In this case, since the predictor serves as an anchor, the feature space of the target dataset can be quickly and accurately aligned with the feature space of the target dataset. For better understanding, a further description will be made with reference to FIG. 17.

FIG. 17 is an example conceptual diagram illustrating a case where the feature space of the target dataset is aligned with the feature space of the source dataset due to an update of the feature extractor. FIG. 17 assumes that the predictor is configured to predict a class label, and a curve illustrated in FIG. 17 indicates a classification curve of the predictor trained using the source dataset.

As illustrated in FIG. 17, if the feature extractor is updated using the target dataset in a state where the predictor is frozen (see the classification curve in the fixed state), the feature space of the target dataset can be quickly and accurately aligned with the feature space of the source dataset. Accordingly, the problem of domain shift (see the left side of FIG. 17) can be easily solved, and the performance of the target model can be greatly improved.

On the other hand, if the feature extractor is updated together with the predictor, the speed at which the feature space of the target dataset and the feature space of the source dataset are aligned may be inevitably slow because the number of weight parameters to be updated increases significantly. In addition, even if the two feature spaces are aligned, the performance of the target model cannot be guaranteed because the classification curve illustrated in FIG. 17 is also shifted.

According to embodiments of the present disclosure, an entropy loss for a confidence score for each class may be further calculated. That is, when the predictor is configured to calculate the confidence score for each class, the entropy loss may be calculated based on an entropy value for the confidence score for each class. Then, the feature extractor may be updated based on the calculated entropy loss (i.e., a weight parameter of the feature extractor may be updated in a direction to reduce the entropy loss). The concept and calculation method of entropy will be already familiar to those skilled in the art, and thus a description thereof will be omitted. The entropy loss may prevent the confidence score for each class from being calculated as an ambiguous value (e.g., prevent each class from having a similar confidence score). For example, the entropy loss may be used to prevent the predictor from outputting an ambiguous confidence score for each class by additionally training the feature extractor so that features extracted from the target dataset move away from a decision (classification) boundary in the feature space. Accordingly, the performance of the target model can be further improved.

In addition, in some embodiments, a total loss may be calculated by aggregating at least one of the first and second consistency losses and the entropy loss based on predetermined weights, and the feature extractor may be updated based on the total loss. For example, the evaluation system 10 may calculate the total loss by aggregating the first consistency loss and the entropy loss based on predetermined weights. Here, a weight assigned to the entropy loss may be greater than or equal to a weight assigned to the first consistency loss. In this case, it has been confirmed that the performance of the target model is further improved. In another example, the evaluation system 10 may calculate the total loss by aggregating the second consistency loss and the entropy loss based on predetermined weights. Here, the weight assigned to the entropy loss may be less than or equal to a weight assigned to the second consistency loss. In this case, it has been confirmed that the performance of the target model is further improved. In another example, as illustrated in FIG. 18, the evaluation system 10 may calculate a total loss 184 by aggregating two consistency losses 181 and 182 and an entropy loss 183 based on predetermined weights W1 through W3. Here, a second weight W2 may be greater than or equal to a first weight W1 and a third weight W3, and the third weight W3 may be set to a value greater than or equal to the first weight W1. In this case, it has been confirmed that the performance of the target model is further improved. For example, the first weight W1 may be set to a value between about 0 and 0.5, the second weight W2 may be set to a value greater than or equal to about 1.0, and the third weight W3 may be set to a value between about 0.5 and 1.0. However, the scope of the present disclosure is not limited thereto.

Referring back to FIG. 15, in operation S156, it is determined whether a termination condition is satisfied. If the termination condition is not satisfied, operations S152 through S155 described above may be repeated. If satisfied, the additional training of the source model may end. Accordingly, the target model may be built.

The termination condition may be variously set based on, for example, loss (e.g., consistency loss, entropy loss, total loss, etc.), learning time, the number of epochs, etc. For example, the termination condition may be set to the condition that a total loss is less than or equal to a reference value. However, the scope of the present disclosure is not limited thereto.

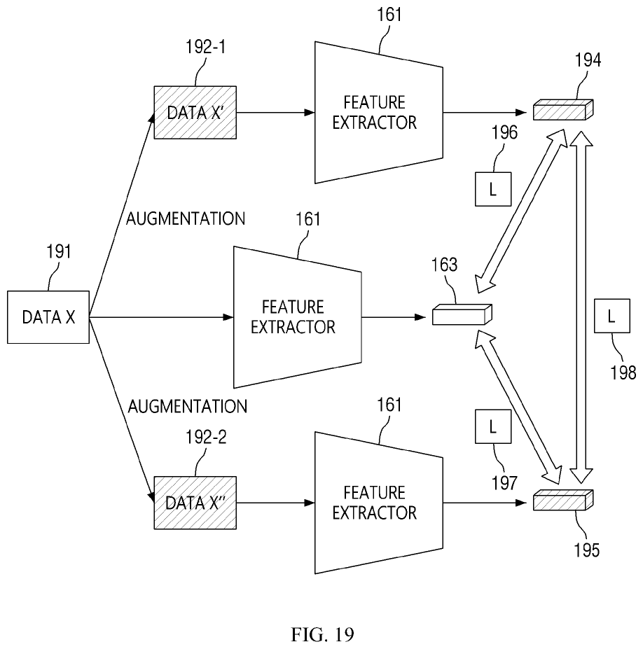

Until now, the unsupervised domain adaptation method according to the embodiments of the present disclosure has been described with reference to FIGS. 15 through 18. Hereinafter, methods of calculating a consistency loss will be described in more detail with reference to FIGS. 19 through 21.

FIG. 19 is an example diagram for explaining a method of calculating a consistency loss according to embodiments of the present disclosure. FIG. 19 illustrates a case where two virtual data samples 192-1 and 192-2 are generated from a data sample 191 of a target dataset. For clarity of the present disclosure, the data sample 191 and the two virtual data samples 192-1 and 192-2 will hereinafter be referred to as a ‘first data sample 191 (see x)’, a ‘second data sample 192-1 (see x’)′, and a ‘third data sample 192-2 (see x″)’, respectively.

As illustrated in FIG. 19, the current embodiments relate to a method of calculating a feature-related consistency loss (i.e., the above-described ‘first consistency loss’).

The evaluation system 10 may extract features 193 through 195 respectively from the first through third data samples 191, 192-1 and 192-2 through a feature extractor 161. In addition, the evaluation system 10 may calculate a consistency loss (e.g., 196) based on a difference (or distance) between the extracted features (e.g., 193 and 194).

For example, the evaluation system 10 may calculate a consistency loss 196 based on a difference between the feature 193 (hereinafter, referred to as a ‘first feature’) extracted from the first data sample 191 and the feature 194 (hereinafter, referred to as a ‘second feature’) extracted from the second data sample 192-1. In addition, the evaluation system 10 may calculate a consistency loss 197 based on the first feature 193 and the feature 195 (hereinafter, referred to as a ‘third feature’) extracted from the third data sample 192-2.

In another example, the evaluation system 10 may calculate a consistency loss 198 between the virtual data samples 192-1 and 192-2 based on a difference between the second feature 194 and the third feature 195.

In another example, the evaluation system 10 may calculate a consistency loss based on various combinations of the above examples. For example, the evaluation system 10 may calculate a total consistency loss by aggregating the consistency losses 196 through 198 based on predetermined weights. Here, a smaller weight may be assigned to the consistency loss 198 between the virtual data samples 192-1 and 192-2 than to the other losses 196 and 197.

In the current embodiments, the difference (or distance) between the features (e.g., 193 and 194) may be calculated by, for example, a cosine distance (or similarity). However, the scope of the present disclosure is not limited thereto. The concept and calculation method of the cosine distance will be already familiar to those skilled in the art, and thus a description thereof will be omitted.

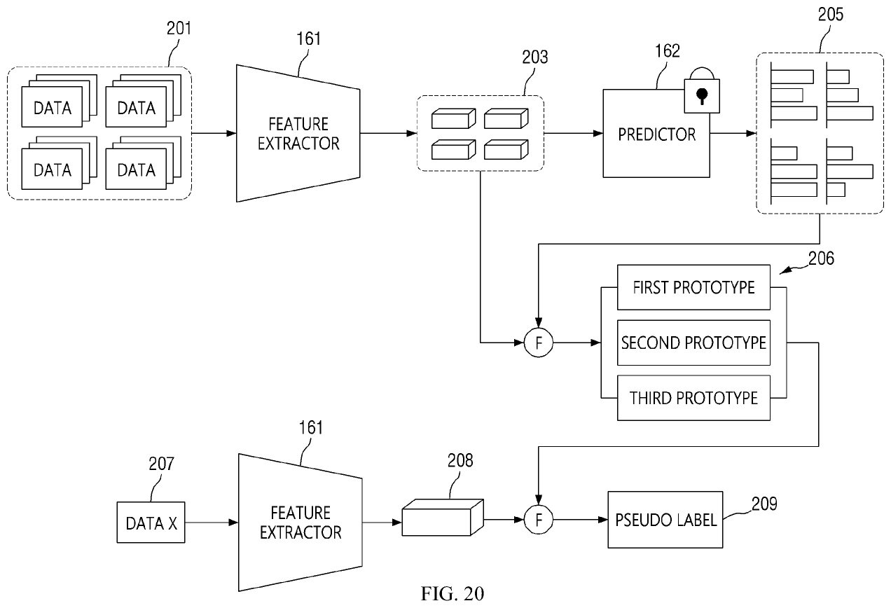

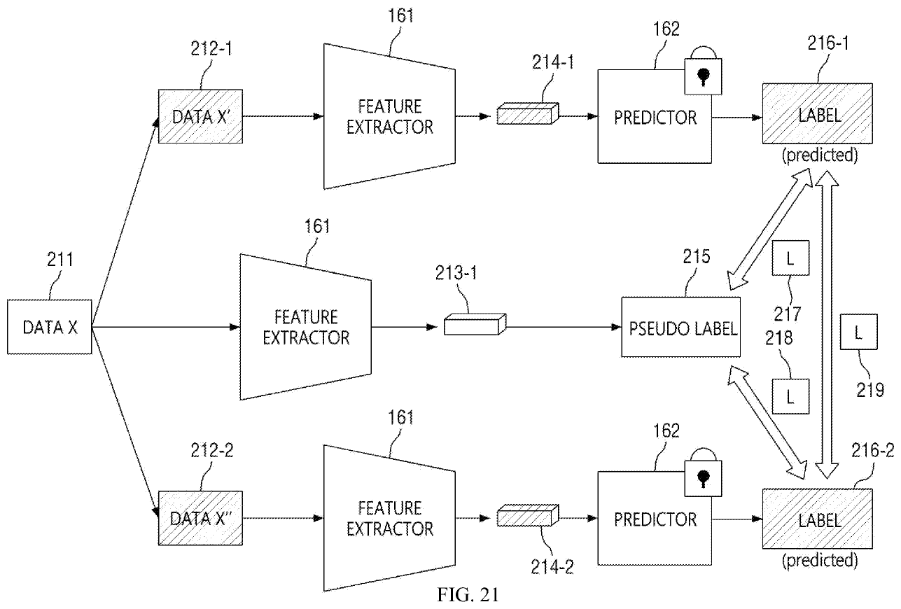

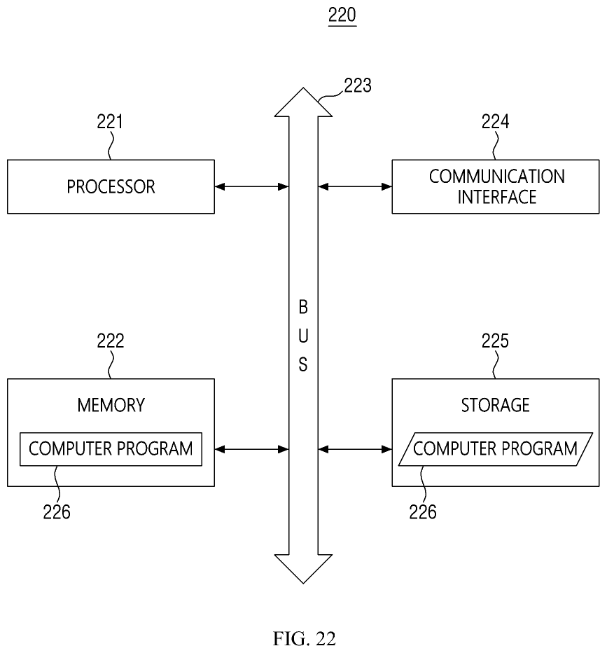

A method of calculating a consistency loss according to embodiments of the present disclosure will now be described with reference to FIGS. 20 and 21.

The current embodiments relate to a method of calculating a label-related consistency loss (i.e., the above-described ‘second consistency loss’), and this consistency loss may be calculated based on a difference between a pseudo label for a selected data sample and a predicted label of a virtual data sample.

First, a method of generating a pseudo label 209 for a data sample 207 will be described with reference to FIG. 20. FIG. 20 assumes that a predictor 162 of a source model is configured to output a confidence score for each class.

As illustrated in FIG. 20, the evaluation system 10 may extract a feature (see 203) from each of a plurality of data samples 201 through a feature extractor 161. Then, the evaluation system 10 may calculate a confidence score 205 for each class from each of the extracted features 203 through the predictor 162. FIG. 20 illustrates a case where the number of classes is three.

Next, the evaluation system 10 may generate a prototype feature 206 for each class by reflecting the confidence score 205 for each class in the features 203 and then aggregating the resultant features. For example, the evaluation system 10 may generate a prototype feature of a first class (see ‘first prototype’) by reflecting (e.g., multiplying) a confidence score of the first class in each of the features 203 and then aggregating (e.g., averaging, multiplying, multiplying by element, etc.) the resultant features. In addition, the evaluation system 10 may generate prototype features of other classes (see ‘second prototype’ and ‘third prototype’) in a similar manner.

Next, the evaluation system 10 may generate a pseudo label 209 of a data sample 207 based on a similarity between a feature 208 extracted from the data sample 207 (see x) and the prototype feature 206 for each class. For example, the evaluation system 10 may calculate a label value for the first class based on the similarity between the extracted feature 208 and the prototype feature of the first class and may calculate label values for other classes in a similar manner. As a result, the pseudo label 209 may be generated.

The similarity between the extracted feature 208 and the prototype feature 206 for each class may be calculated using various methods such as cosine similarity and inner product, and any method can be used to calculate the similarity.

According to the current embodiments, the prototype feature 206 for each class can be accurately generated by weighting and aggregating the features 203 extracted from the data samples 201 based on the confidence score 205 for each class. As a result, the pseudo label 209 for the data sample 207 can be accurately generated.

In the current embodiments, the data samples 201 may be determined in various ways. For example, the data samples 201 may be samples belonging to a batch of data samples 207 for which pseudo labels are to be generated. In this case, the prototype feature (e.g., 206) for each class may be generated for each batch. In another example, the data samples 201 may be samples selected from a target dataset based on the confidence score for each class. In other words, the evaluation system 10 may select at least one data sample, in which the confidence score of the first class is equal to or greater than a reference value, from the target dataset and then generate a prototype feature of the first class by reflecting the confidence score of the first class in a feature of the selected data sample. In addition, the evaluation system 10 may generate prototype features of other classes in a similar manner. In this case, the prototype feature (e.g., 206) for each class can be generated more accurately.

As described above, when a pseudo label for a selected data sample is generated, the evaluation system 10 may calculate a consistency loss (i.e., the second consistency loss) based on a difference between a predicted label for a virtual data sample and the pseudo label. For example, the evaluation system 10 may predict a label of the virtual data sample through the feature extractor 161 and the predictor 162 (i.e., through a feed-forward process on the source model) and calculate the second consistency loss based on a difference between the predicted label (e.g., the confidence score for each class) and the pseudo label of the selected data sample. If the predictor 162 is configured to output the confidence score for each class, the difference between the predicted label and the pseudo label may be calculated based on, for example, a cross entropy function. However, the scope of the present disclosure is not limited thereto. For better understanding, the above operation will be further described with reference to FIG. 21.

FIG. 21 illustrates, like FIG. 19, a case where two virtual data samples 212-1 and 212-2 are generated from a data sample 211 of a target dataset. For clarity of the present disclosure, the data sample 211 and the two virtual data samples 212-1 and 212-2 will be referred to as a ‘first data sample 211 (see x)’, a ‘second data sample 212-1 (see x’)′, and a ‘third data sample 212-2 (see x″)’, respectively. For reference, a lock symbol shown on a predictor 162 in FIG. 21 indicates that the predictor 162 is in a frozen state.

As illustrated in FIG. 21, the evaluation system 10 may generate a pseudo label 215 using a feature 213-1 extracted from the first data sample 211. This may be understood from the description of FIG. 20.

Next, the evaluation system 10 may extract features 214-1 and 214-2 from the second data sample 212-1 and the third data sample 212-2 through a feature extractor 161. Then, the evaluation system 10 may input the extracted features 214-1 and 214-2 to the predictor 162 and predict labels 216-1 and 216-2 of the data samples 212-1 and 212-2.

Next, the evaluation system 10 may calculate consistency losses 217 and 218 based on differences between the pseudo label 215 and the predicted labels 216-1 and 216-2. For example, the evaluation system 10 may calculate the consistency loss 217 between the first data sample 211 and the second data sample 212-1 based on the difference (e.g., cross entropy) between the pseudo label 215 and the predicted label 216-1 and may calculate the consistency loss 218 between the first data sample 211 and the third data sample 212-2 based on the difference (e.g., cross entropy) between the pseudo label 215 and the predicted label 216-2.

In some cases, the evaluation system 10 may further calculate a consistency loss 219 between the virtual data samples 212-1 and 212-2 based on a difference between the predicted labels 216-1 and 216-2.

In addition, in some cases, the evaluation system 10 may calculate a total consistency loss by aggregating the exemplified consistency losses 217 through 219 based on predetermined weights. Here, a smaller weight may be assigned to the consistency loss 219 between the virtual data samples 212-1 and 212-2 than to the other losses 217 and 218.

Until now, various embodiments of the consistency loss calculation method have been described in detail with reference to FIGS. 19 through 21. According to the above description, the feature-related consistency loss (i.e., the ‘first consistency loss’) and the label-related consistency loss (i.e., the ‘second consistency loss’) can be accurately calculated, and a high-performance target model can be built by training the feature extractor (e.g., 161) using the calculated consistency loss.

Until now, the unsupervised domain adaptation method according to the embodiments of the present disclosure has been described with reference to FIGS. 15 through 21. According to the above description, domain adaptation may be performed on a source model using only an unlabeled dataset of a target domain (i.e., in an unsupervised manner). Therefore, domain adaptation can be easily performed even in an environment in which access to a labeled dataset of a source domain is restricted due to reasons such as security and privacy. In addition, a high-performance target model can be built by aligning a feature space of a target dataset (or domain) with a feature space of a source dataset (or domain) based on a consistency loss.

Results of experiments conducted on the performance evaluation method (hereinafter, referred to as a ‘proposed method’) according to the embodiments of the present disclosure will now be briefly described.

The inventors of the present disclosure conducted an experiment to measure the actual accuracy (see ‘actual accuracy’) of a source model using a labeled dataset of a target domain and evaluate the actual accuracy (see ‘predicted accuracy’) of the source model using the same dataset without a label according to the method exemplified in FIG. 3. The adversarial noise of each data sample was adaptively derived according to Equation 2. The results of the experiment are shown in Table 1. Here, MNIST, Steet View House Numbers (SVHN), United States Postal Service (USPS), Amazon (office-31 dataset), and Visual Domain Adaptation (VisDA) datasets shown in Table 1 will be already familiar to those skilled in the art, and thus a description thereof will be omitted.

TABLE 1

| Source | Target | Actual | Predicted |
|---|---|---|---|
| dataset | dataset | accuracy (%) | accuracy (%) |
| MNIST | SVHN | 42.5 | 41.4 |
| | USPS | 97.8 | 97.5 |
| Amazon | DSLR | 81.5 | 82.9 |
| | Webcam | 75.2 | 77.4 |
| VisDA (synthetic) | VisDA (actual) | 57.7 | 56.8 |

As shown in Table 1, the accuracy of the source model evaluated by the proposed method is hardly different from the actual accuracy measured through the labeled dataset, and an evaluation error of the proposed method is maintained at a very small value regardless of the source domain and the target domain. Accordingly, it can be seen that the actual performance of a model can be accurately evaluated if a pseudo label of an evaluation dataset is generated according to the above-described method.

In addition, in order to find out the effect of adaptive adversarial noise on the accuracy of performance evaluation, the present inventors conducted an experiment to measure a mean absolute error (MAE), which represents a difference between actual accuracy and predicted accuracy, by changing the type and number of factors. The present inventors calculated an average MAE by alternately designating Amazon, DSLR, and Webcam datasets as a source dataset and a target dataset and repeatedly measuring the MAE. The results of the experiment are shown in Table 2 below.

TABLE 2

| | | Upper limit of | Average |
|---|---|---|---|
| Configuration | | adversarial noise | MAE (%) |
| Fixed | Configuration 1 | ε₀ | 4.72 |
| Adaptive | Configuration 2 | ε₀ * | 4.70 |
| | | (C_{unc} + C_{div}) | |
| | Configuration 3 | ε₀ * C_{den} * | 4.43 |
| | | (C_{unc} + C_{div}) | |
| | Configuration 4 | ε₀ * C_{cls} * | 3.05 |
| | | (C_{unc} + C_{div}) | |
| | Configuration 5 | ε₀ * C_{cls} * | 2.51 |
| | | C_{den} * (C_{unc} + C_{div}) | |

Referring to Table 2, it can be seen that the accuracy of performance evaluation is more improved (note that the average MAE is smaller) when adversarial noise is derived adaptively (see ‘Configurations 2 through 5’) than when adversarial noise is not derived adaptively (see ‘Configuration 1’). In addition, it can be seen that as the number of factors used to derive adversarial noise increases, the accuracy of performance evaluation improves.

Until now, the results of the experiments on the performance evaluation method according to the embodiments of the present disclosure have been briefly described with reference to Tables 1 and 2. Hereinafter, an example computing device 220 that can implement the evaluation system 10 according to the embodiments of the present disclosure will be described with reference to FIG. 22.

FIG. 22 illustrates the example hardware configuration of a computing device 220.

Referring to FIG. 22, the computing device 220 may include one or more processors 221, a bus 223, a communication interface 224, a memory 222 which loads a computer program 226 to be executed by the processors 221, and a storage 225 which stores the computer program 226. In FIG. 22, only the components related to the embodiments of the present disclosure are illustrated. Therefore, it will be understood by those of ordinary skill in the art to which the present disclosure pertains that other general-purpose components can be included in addition to the components illustrated in FIG. 22. That is, the computing device 220 may further include various components other than the components illustrated in FIG. 22. In addition, in some cases, some of the components illustrated in FIG. 22 may be omitted from the computing device 220. Each component of the computing device 220 will now be described.

The processors 221 may control the overall operation of each component of the computing device 220. The processors 221 may include at least one of a central processing unit (CPU), a micro-processor unit (MPU), a micro-controller unit (MCU), a graphic processing unit (GPU), and any form of processor well known in the art to which the present disclosure pertains. In addition, the processors 221 may perform an operation on at least one application or program for executing operations/methods according to embodiments of the present disclosure. The computing device 220 may include one or more processors.

Next, the memory 222 may store various data, commands and/or information. The memory 222 may load the computer program 226 from the storage 225 in order to execute operations/methods according to embodiments of the present disclosure. The memory 222 may be implemented as a volatile memory such as a random access memory (RAM), but the technical scope of the present disclosure is not limited thereto.

Next, the bus 223 may provide a communication function between the components of the computing device 220. The bus 223 may be implemented as various forms of buses such as an address bus, a data bus, and a control bus.

Next, the communication interface 224 may support wired and wireless Internet communication of the computing device 220. In addition, the communication interface 224 may support various communication methods other than Internet communication. To this end, the communication interface 224 may include a communication module well known in the art to which the present disclosure pertains.

Next, the storage 225 may non-temporarily store one or more programs 226. The storage 225 may include a nonvolatile memory such as a read only memory (ROM), an erasable programmable ROM (EPROM), an electrically erasable programmable ROM (EEPROM) or a flash memory, a hard disk, a removable disk, or any form of computer-readable recording medium well known in the art to which the present disclosure pertains.

Next, the computer program 226 may include one or more instructions for controlling the processors 221 to perform operations/methods according to various embodiments of the present disclosure when the computer program 226 is loaded into the memory 222. That is, the processors 221 may perform the operations/methods according to the various embodiments of the present disclosure by executing the loaded instructions.

For example, the computer program 226 may include instructions for performing an operation of obtaining a first model trained using a labeled dataset of a source domain, an operation of obtaining a second model built by performing domain adaptation to a target domain on the first model, an operation of generating a pseudo label for an evaluation dataset of the target domain using the second model, and an operation of evaluating the performance of the first model using the pseudo label.

In another example, the computer program 226 may include instructions for performing at least some of the steps/operations described with reference to FIGS. 1 through 21.

In the illustrated case, the evaluation system 10 according to the embodiments of the present disclosure may be implemented through the computing device 220.

In some embodiments, the computing device 220 illustrated in FIG. 22 may be a virtual machine implemented based on cloud technology. For example, the computing device 220 may be a virtual machine operating on one or more physical servers included in a server farm. In this case, at least some of the processors 221, the memory 222, and the storage 225 illustrated in FIG. 22 may be virtual hardware, and the communication interface 224 may also be a virtualized networking element such as a virtual switch.

Until now, an example computing device 220 that can implement the evaluation system 10 according to the embodiments of the present disclosure has been described with reference to FIG. 22.

Embodiments of the present disclosure have been described above with reference to FIGS. 1 through 22, but it should be noted that the effects of the present disclosure are not limited to those described above, and other effects of the present disclosure should be apparent from the following description.

The technical features of the present disclosure described so far may be embodied as computer readable codes on a computer readable medium. The computer program recorded on the computer readable medium may be transmitted to other computing device via a network such as internet and installed in the other computing device, thereby being used in the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

The protection scope of the present invention should be interpreted by the following claims, and all technical ideas within the equivalent range should be interpreted as being included in the scope of the technical ideas defined by the present disclosure.

What is claimed is:

1. A performance evaluation method performed by at least one computing device,
the method comprising:
obtaining a first model trained using a labeled dataset of a source domain;
obtaining a second model built by performing domain adaptation to a target domain on the first model;
generating a pseudo label for an evaluation dataset of the target domain using the second model; and
evaluating a performance of the first model using the pseudo label,
wherein the evaluation dataset is an unlabeled dataset, and the generating of the pseudo label comprises:
adjusting an upper limit of a size constraint of adversarial noise based on a predefined factor;
deriving the adversarial noise for a data sample belonging to the evaluation dataset within a range that satisfies the size constraint according to the adjusted upper limit;
generating a noisy sample by reflecting the derived adversarial noise in the data sample; and
generating a pseudo label for the data sample based on a predicted label of the noisy sample obtained through the second model.

2. The method of claim 1, wherein the domain adaptation is performed using an unlabeled dataset of the target domain.

3. The method of claim 1, wherein the domain adaptation and the generating of the pseudo label are performed without using the labeled dataset.

4. The method of claim 1, wherein the obtaining of the second model comprises:
monitoring a training loss calculated during a domain adaptation process;
determining a time when an amount of change in the training loss is equal to or less than a reference value as an early stop time; and
obtaining the second model by stopping the domain adaptation at the determined early stop time.

5. The method of claim 1, wherein the adjusting of the upper limit of the size constraint comprises:
adjusting a first upper limit applied to a size constraint of a first data sample belonging to the evaluation dataset; and
adjusting a second upper limit applied to a size constraint of a second data sample belonging to the evaluation dataset,
wherein the adjusted first upper limit is different from the adjusted second upper limit.

6. The method of claim 1, wherein the predefined factor comprises a first factor related to characteristics of the evaluation dataset and a second factor related to characteristics of the data sample.

7. The method of claim 1, wherein the adjusting of the upper limit of the size constraint comprises:
measuring predictive uncertainty of the second model for the data sample; and
adjusting the upper limit based on the predictive uncertainty.

8. The method of claim 7, wherein the measuring of the predictive uncertainty comprises:
obtaining a plurality of predicted labels by applying a drop-out technique to at least a portion of the second model and repeating prediction for the data sample;
determining a class with a highest average confidence score among the plurality of predicted labels; and
measuring the predictive uncertainty for the data sample based on confidence scores of the determined class included in the plurality of predicted labels,
wherein values of the plurality of predicted labels are confidence scores for each class.

9. The method of claim 1, wherein the adjusting of the upper limit of the size constraint comprises:
obtaining a first predicted label for the data sample through the first model;
obtaining a second predicted label for the data sample through the second model; and
adjusting the upper limit based on a difference between the first predicted label and the second predicted label.

10. The method of claim 9, wherein the difference between the first predicted label and the second predicted label is calculated based on Jensen-Shannon divergence (JSD).

11. The method of claim 1, wherein the adjusting of the upper limit of the size constraint comprises adjusting the upper limit based on a degree of dispersion of data samples of the evaluation dataset.

12. The method of claim 11, wherein the data samples are images, and the adjusting of the upper limit based on the degree of dispersion of the data samples of the evaluation dataset comprises:
calculating a representative vale of each of the data samples based on a pixel value of each of the data samples; and
measuring the degree of dispersion of the data samples based on a degree of dispersion of calculated representative values.

13. The method of claim 12, wherein the degree of dispersion of the representative values is a first degree of dispersion, and the measuring of the degree of dispersion of the data samples based on the degree of dispersion of the calculated representative values comprises:
obtaining a second degree of dispersion of data samples of the labeled dataset from training history data of the labeled dataset of the source domain without accessing the labeled dataset; and
calculating a degree of dispersion of the data samples based on a ratio of the first degree of dispersion to the second degree of dispersion.

14. The method of claim 1, wherein the adjusting of the upper limit of the size constraint comprises adjusting the upper limit based on a number of classes of the evaluation dataset.

15. The method of claim 1, wherein the deriving of the adversarial noise comprises:
obtaining a first predicted label for the data sample through the second model;
generating a specific noisy sample by reflecting a value of a noise parameter in the data sample;
obtaining a second predicted label for the specific noisy sample through the second model;
updating the value of the noise parameter in a direction to increase a difference between the first predicted label and the second predicted label; and
calculating the adversarial noise for the data sample based on the updated value of the noise parameter.

16. The method of claim 1, wherein the evaluating of the performance of the first model comprises:
predicting a label of the evaluation dataset through the first model; and
evaluating the performance of the first model by comparing the pseudo label and the predicted label.

17. A performance evaluation system comprising:
one or more processors; and
a memory configured to store a computer program which is to be executed by the one or more processors,
wherein the computer program comprises instructions for performing:
an operation of obtaining a first model trained using a labeled dataset of a source domain;
an operation of obtaining a second model built by performing domain adaptation to a target domain on the first model;
an operation of generating a pseudo label for an evaluation dataset of the target domain using the second model; and
an operation of evaluating a performance of the first model using the pseudo label,
wherein the evaluation dataset is an unlabeled dataset, and the operation of generating the pseudo label comprises:
an operation of adjusting an upper limit of a size constraint of adversarial noise based on a predefined factor;
an operation of deriving the adversarial noise for a data sample belonging to the evaluation dataset within a range that satisfies the size constraint according to the adjusted upper limit;
an operation of generating a noisy sample by reflecting the derived adversarial noise in the data sample; and
an operation of generating a pseudo label for the data sample based on a predicted label of the noisy sample obtained through the second model.

18. A non-transitory computer-readable recording medium configured to store a computer program to be executed by one or more processors to perform:
obtaining a first model trained using a labeled dataset of a source domain;
obtaining a second model built by performing domain adaptation to a target domain on the first model;
generating a pseudo label for an evaluation dataset of the target domain using the second model; and
evaluating a performance of the first model using the pseudo label,
wherein the evaluation dataset is an unlabeled dataset, and the generating of the pseudo label comprises:
adjusting an upper limit of a size constraint of adversarial noise based on a predefined factor;
deriving the adversarial noise for a data sample belonging to the evaluation dataset within a range that satisfies the size constraint according to the adjusted upper limit;
generating a noisy sample by reflecting the derived adversarial noise in the data sample; and
generating a pseudo label for the data sample based on a predicted label of the noisy sample obtained through the second model.
